(19) United States
(12) Patent Application Publication
(10) Pub. No.: US 2024/0002717 A1
(43) Pub. Date: Jan. 4, 2024

(54) SWITCHABLE POLYMERS THAT REDUCE WATER PRODUCTION IN A HYDROCARBON-PRODUCING WELL

(71) Applicant: Saudi Arabian Oil Company, Dhahran (SA)

(72) Inventors: Rajesh Kumar Saini, Cypress, TX (US); Amy J. Cairns, Houston, TX (US)

(21) Appl. No.: 17/852,468

(22) Filed: Jun. 29, 2022

(51) Int. Cl. C09K 8/514; C09K 8/516

(52) U.S. Cl. CPC C09K 8/514; C09K 8/516

(57) ABSTRACT

Systems and methods for selectively reducing water production in a well. The interior of the well casing is in fluid communication with a subterranean formation with a hydrocarbon-producing zone and a water-producing zone. The subterranean formation has a switchable polymer in contact with at least one of the hydrocarbon-producing zone and the water-producing zone. The switchable nature of the polymer enables a hydrophobic state and a hydrophilic state and fluid communication between the water-producing zone and the interior of the well casing is greater when the polymer is in its hydrophilic state than when the polymer is in its hydrophobic state. In its hydrophilic state, more of the polymer will invade the water-producing zone but the plugging action will not take place until it is switched to the hydrophobic state.

### FIELD

The disclosure relates to polymers that reduce excess water production in a hydrocarbon-producing well. The stimuli-responsive polymers can be triggered to reversibly switch between a hydrophilic state and hydrophobic state. The aqueous polymeric solution in hydrophilic state is pumped through the wellbore in the oil bearing and water bearing zone of the formation. The aqueous polymer was allowed to switch to hydrophobic state. In hydrophobic state it forms thick gel or precipitates. In water bearing zone this gel or precipitate plug the pores thus reduce or stop water production. In oil bearing zone the gel or precipitate dissolve in hydrocarbon fluid thus leaving the oil producing zone unobstructed. The result is a hydrocarbon-producing well that can beneficially produce a desired hydrocarbon (e.g., oil and/or gas) with little to no water production.

### BACKGROUND

FIG. 1 schematically depicts a system 1000 that includes a hydrocarbon-producing (e.g., oil-producing and/or gas-producing) well 1100 having a first portion 1110 above a surface of the earth 1200 and a second portion 1120 that extends below the surface 1200 and into a subterranean rock formation 1300. The portion 1120 includes a casing 1122 having perforations 1124. The subterranean rock formation 1300 includes a hydrocarbon-producing (e.g., oil-producing and/or gas-producing) zone 1400 and a water-producing zone 1500. The well 1100 is designed so that the perforations 1124 allow for fluid communication between an interior region 1126 of the casing 1122 and the hydrocarbon-producing zone 1400. In some cases, there may be unintentional fluid communication between the interior region 1126 of the casing 1122 and the water producing zone 1500. For example, a fracture 1600 may be present in the subterranean rock formation 1300, wherein the fracture 1600 provides a path of fluid communication between the water-producing zone 1500 and the hydrocarbon-producing zone 1400, thereby putting the water-producing zone 1500 in fluid communication with the interior region 1126 of the casing 1122.

### SUMMARY

The disclosure relates to polymers that can switch between a hydrophilic state and a hydrophobic state for use in a well producing a hydrocarbon and water. The polymer can invade a rock formation containing hydrocarbon producing zones and water producing zones. Polymers present in the water-producing zones switch from their hydrophilic form to their hydrophobic form due to the buffering action of the formation, the heat of the formation and/or injection of a gas. The hydrophobic form of the polymers can form a thick gel or precipitate to block pores of the water-producing zone thereby reducing (e.g., preventing) production of water. The polymers present in the hydrocarbon-producing zone can also switch due to the buffering action of the formation, the heat of the formation and/or injection of a gas. However, a hydrophobic fluid in the hydrocarbon-producing zone can dissolve the hydrophobic polymer thereby leaving the pores of the hydrocarbon-producing zone unblocked.

Generally, produced water is not suitable for consumption or agricultural use. Hence, the polymers can reduce environmental issues, safety hazards, and financial costs associated with the treatment and/or disposal of water produced from hydrocarbon-producing wells. Additionally or alternatively, the polymers can reduce scale and/or corrosion of pipes resulting from water production, thereby reducing costs associated with addressing issues resulting from such scaling or corrosion. In general, the polymers can increase hydrocarbon recovery, reduce costs, increase profits and reduce early abandonment of a well.

The polymers can be relatively inexpensive and readily placed to the zone of interest without needing specialized equipment (e.g., coiled tubing). The polymer contains functional group(s) that enables controllable switching from hydrophilic to hydrophobic states, for example to ensure proper placement and/or sufficient matrix invasion before switching. In some embodiments, the polymers can be switched from the hydrophobic state back to the hydrophilic state by adding an acidic solution, which can reduce (e.g., prevent) permanent plugging and/or other damage that might otherwise occur. In certain embodiments, precipitates and/or gels formed by the polymers can have relatively good strength, relatively good stability, and/or relatively good compatibility with water, surfactants, caustic and acidic conditions, and formation ions and brines.

Generally, when in its hydrophilic state, the polymer is soluble in water, and, when in its hydrophobic state, the polymer is insoluble in water. In general, when in its hydrophobic state, the polymer is soluble in a fluid (e.g., a hydrocarbon-containing fluid) in the hydrocarbon-producing zone. In certain embodiments, when in its hydrophobic state, the polymer forms a gel in water and/or a precipitate in water.

In general, the polymer can be switched between the hydrophilic and hydrophobic forms. In some embodiments, the polymer can be switched by changing the pH of a liquid that contains the polymer. In some embodiments, the pH can be changed by adding or removing carbon dioxide (CO₂) from the liquid that contains the polymer. In certain embodiments, CO₂ can be removed from the liquid that contains the polymer by increasing the temperature of the liquid. In some embodiments, CO₂ can be removed from the liquid that contains the polymer by flowing a gas through the liquid. In certain embodiments, the pH of a liquid containing the polymer can be decreased by adding an acid (e.g., hydrochloric acid (HCl)) to the liquid. In some embodiments, the pH of a liquid containing the polymer can be increased by adding a base (e.g., sodium hydroxide (NaOH)) to the liquid. In some embodiments, the pH of a liquid containing the polymer can be altered by the buffering action of the reservoir. In some embodiments, the properties of the polymer may be adjusted based on water production problems and/or reservoir conditions.

In a first aspect, the disclosure provides a system, including a well with a well casing having an interior; and a polymer in both a water-producing zone of a subterranean rock formation and in a hydrocarbon-producing zone of the subterranean rock formation. The polymer has a hydrophobic state and a hydrophilic state. When the polymer is in its hydrophilic state it is pumped in the formation and the interior of the well casing is in fluid communication with both the hydrocarbon-producing zone and the water-producing zone. Once in the formation the fluid switches to hydrophobic state, the water bearing zone gets plugged or reduced water production but the oil bearing zone does not.

In some embodiments, the polymer is synthesized by free radical polymerization of a monomer selected from the group consisting of acrylamide, vinyl pyrrolidone, N,N-dimethylaminoethyl methacrylate (DMAEMA), N,N-diethylaminoethyl methacrylate (DEAEMA), 3-N′,N′-dimethylaminopropyl acrylamide, N,N-diethylaminoacrylamide (DEAA), N,N-dimethyl acrylamide (DMAAm), N-isopropyl acrylamide (NIPAm), N-isopropylmethacrylamide (NIPMAm), 4-vinyl pyridine, 2-vinyl pyridine, acrylated ethyleneimine, (N-amidino)dodecyl acrylamide, N[3-(dimethylamino)propyl] methacrylamide (DMAPMAm), diallyl amine, 2-N-morpholinoethyl methacrylate (MEMA), acrylamide (Am), N,N-dimethylaminoethyl acrylate (DMAEA), N,N-diethylaminoethyl acrylamide (DEAEAm), N,N-dimethylvinylbenzylamine, N,N-diethylvinylbenzylamine, N,N-dipropylvinylbenzylamine, N-vinyl pyridine, and N-vinylimidazole.

In some embodiments, the polymer is a homopolymer, copolymer or terpolymer.

In some embodiments, the polymer is graft copolymer.

In some embodiments, the polymer is a biopolymer, such as, for example, guar, cellulose, CMC, or CMHPG.

In some embodiments, in its hydrophobic state, the polymer prevents or reduces fluid communication between the interior of the well casing and the water-producing zone.

In some embodiments, when the polymer is in its hydrophobic state, the polymer is soluble in a hydrocarbon fluid in the hydrocarbon-producing zone so that the polymer does not block fluid communication between the interior of the well casing and the hydrocarbon-producing zone.

In some embodiments, when the polymer is heated, the polymer switches from its hydrophilic state to its hydrophobic state.

In some embodiments, as a pH of a liquid including the polymer is increased, the polymer switches from its hydrophilic state to its hydrophobic state.

In some embodiments, when the polymer and carbon dioxide are dissolved in a liquid and carbon dioxide is removed from the liquid, the polymer switches from its hydrophilic state to its hydrophobic state.

In some embodiments, the hydrophilic state of the polymer includes a cation of a salt.

In some embodiments, the salt includes a member selected from the group consisting of a bicarbonate salt and a chloride salt.

In some embodiments, a functional group of the polymer is deprotonated when the polymer switches from its hydrophilic state to its hydrophobic state.

In some embodiments, the functional group has a neutral charge when deprotonated and a positive charge when protonated.

In some embodiments, the functional group has a pK_{aH} of from 3 to 7.

In some embodiments, the system further includes a liquid including the polymer, wherein the mole ratio between the functional group and a bicarbonate anion in the liquid is from 1:1 to 1:20.

In some embodiments, the functional group includes a member selected from the group consisting of amines, amidines, guanidines, imidazole and carboxylic acid.

In some embodiments, the polymer further includes a hydrophobic functional group.

In some embodiments, the functional group includes at least one member selected from the group consisting of N,N-dimethylaminoethyl methacrylate (DMAEMA), N,N-diethylaminoethyl methacrylate (DEAEMA), 3-N′,N′-dimethylaminopropyl acrylamide, N,N-diethylaminoacrylamide (DEAA), N,N-dimethyl acrylamide (DMAAm), N-isopropyl acrylamide (NIPAm), N-isopropylmethacrylamide (NIPMAm), 4-vinyl pyridine, 2-vinyl pyridine, acrylated ethyleneimine, (N-amidino)dodecyl acrylamide, N[3-(dimethylamino)propyl] methacrylamide (DMAPMAm), diallyl amine, 2-N-morpholinoethyl methacrylate (MEMA), acrylamide (Am), N,N-dimethylaminoethyl acrylate (DMAEA), N,N-diethylaminoethyl acrylamide (DEAEAm), N,N-dimethylvinylbenzylamine, N,N-diethylvinylbenzylamine, N,N-dipropylvinylbenzylamine, N-vinyl pyridine, and N-vinylimidazole.

In a second aspect, the disclosure provides a method of reducing water production in a hydrocarbon-producing well in fluid communication with both a water-producing zone of a subterranean formation and a hydrocarbon-producing zone of the subterranean formation; a polymer being disposed in both the hydrocarbon-producing zone and the water-producing zone; and the polymer having a hydrophilic state and a hydrophobic state. The method includes switching the polymer from its hydrophilic state to its hydrophobic state to reduce fluid communication between an interior of a well casing of the well and the water-producing zone.

In certain embodiments, after switching the polymer to its hydrophobic state, a fluid is flowed from the hydrocarbon-producing zone to the well.

In certain embodiments, switching the polymer to its hydrophobic state includes heating the polymer.

In certain embodiments, the polymer is in a liquid, and switching the polymer to its hydrophobic state includes exposing the liquid to a gas.

In certain embodiments, the polymer and carbon dioxide are dissolved in a liquid, and switching the polymer to its hydrophobic state includes removing carbon dioxide from the liquid.

In a third aspect, the disclosure provides a method for excess water control for a hydrocarbon producing well. The method includes providing a polymer capable of being reversibly switched between a hydrophobic state and a hydrophilic state by converting neutral state of polymer to forming its salt with acidic groups. The method also includes forming a fluid comprising the polymer in an aqueous medium by converting to the hydrophilic state by forming its salt. The method further includes pumping the hydrophilic fluid or gel through the well into the oil producing zone and water producing zone in the formation. In addition, the method includes allowing the hydrophilic gel to switch to hydrophobic state by action of heat, passing formation gas or by buffering action of formation or a combination thereof Inn its hydrophobic state, the polymer forms a gel or precipitate that plugs the water producing zone to reduce or stop water production. When present in the hydrocarbon zone, the polymer in its hydrophobic state dissolves in the hydrocarbon leaving the oil producing zone unobstructed.

In general, the third aspect can encompass of the embodiments referred to above and/or elsewhere within this disclosure.

### BRIEF DESCRIPTION OF THE FIGURES

FIG. 1 schematically depicts a system that includes a well and a subterranean rock formation.

FIG. 2 schematically depicts a system that includes a well, a subterranean rock formation and a switchable polymer.

FIG. 3a is a scheme for a chemical reaction.

FIG. 3b is a scheme for a chemical reaction.

FIG. 4 is set of chemical structures.

FIG. 5a is a scheme for a chemical reaction.

FIG. 5b is a scheme for a chemical reaction.

FIG. 6 is set of chemical structures.

FIG. 7a is a photograph of a polymer.

FIG. 7b is a photograph of a polymer solution.

FIG. 8 is a plot of viscosity as a function of RPM.

FIG. 9 is a series of photographs of a polymer solution under different conditions.

### DETAILED DESCRIPTION

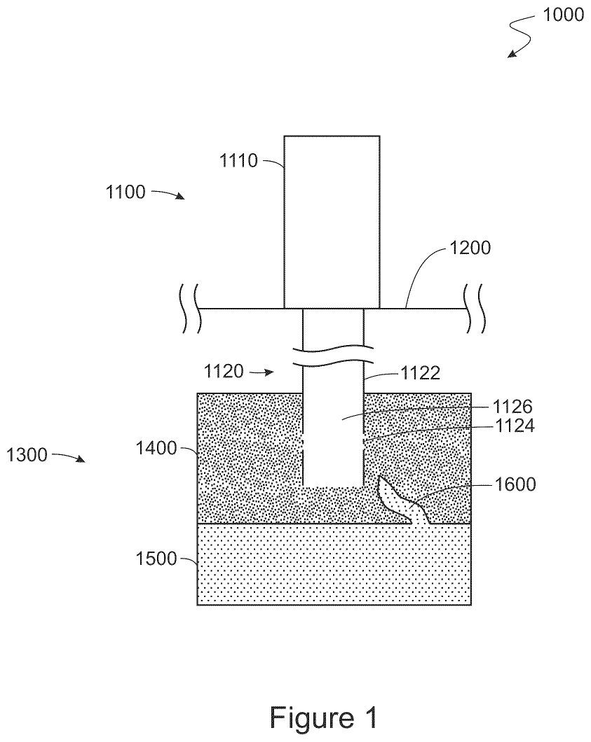

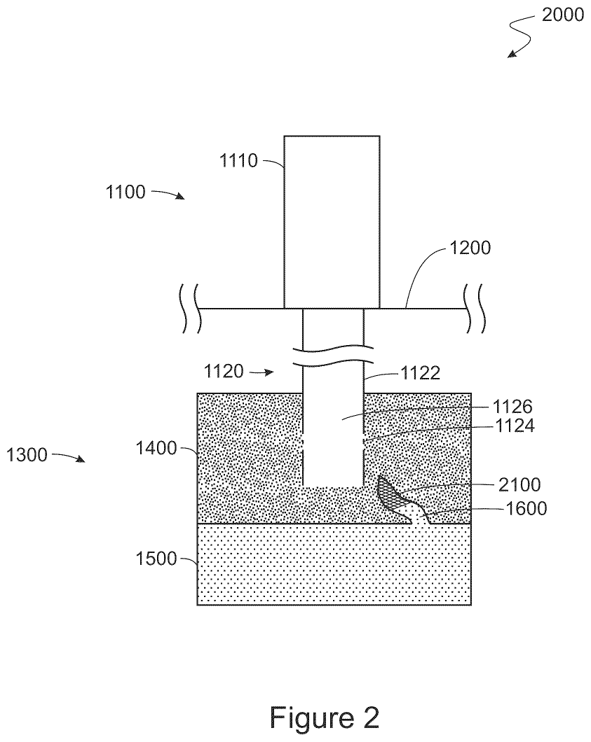

FIG. 2 schematically depicts a system 2000 with corresponding components as in the system 1000 shown in FIG. 1. However, unlike the system 1000, the system 2000 includes a switchable polymer 2100 disposed in the fracture 1600. When the switchable polymer 2100 is in its hydrophilic state, the polymer 2100 allows for fluid communication between the water-producing zone 1500 and interior 1126 of the casing 1122. When the switchable polymer 2100 is in its hydrophobic state, the polymer 2100 reduces (e.g., prevents) fluid communication between the water-producing zone 1500 and the interior 1126 of the casing 1122. At the same time, when the polymer is in its hydrophobic state, the polymer allows for fluid communication between the hydrocarbon-producing zone 1400 and the interior 1126 of the casing 1122. Thus, for example, the polymer 2100 can be disposed (e.g., injected, such as by bullheading) in the subterranean rock formation 1300, including in the fracture 1600, in its hydrophilic state and then switched to its hydrophobic state, thereby reducing (e.g., preventing) fluid communication between the water-producing zone 1500 and the interior 1126 of the casing 1122 while still allowing for fluid communication between the hydrocarbon-producing zone 1400 and the interior 1126 of the casing 1122.

While FIG. 2 depicts a particular mechanism that allows for fluid communication between the water-producing zone 1500 and the interior 1126 of the casing 1122, the disclosure is not limited to such mechanisms of fluid communication. More generally, the polymer can be used in embodiments where fluid communication from the water-producing zone and the interior of the well casing is caused by casing leaks, flow behind the pipe, unfractured wells (injectors or producers) with effective barriers to crossflow, 2-D coning through a hydraulic fracture from an aquifer, natural fracture system leading to an aquifer, faults or fractures crossing a deviated or horizontal well, single fracturing causing channeling between wells, natural fracture system allowing channeling between wells, 3-D coning, cusping, channeling through strata (no fractures) with crossflow and/or single zone (no fracture) with a high mobile water saturation.

In general, the switchable polymers of the disclosure are polymers that change from a hydrophobic state to a hydrophilic state, or vice-versa, in response to a change in one or more stimuli (e.g., pH).

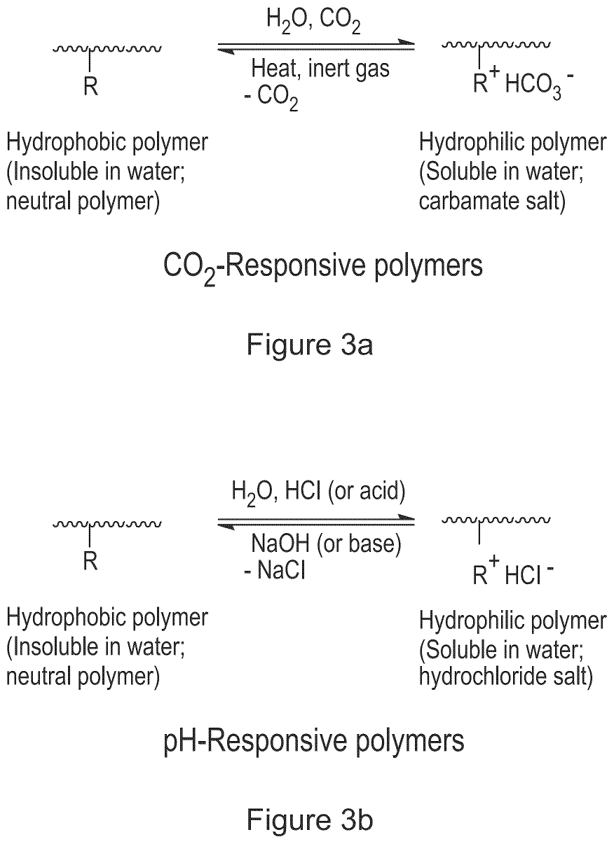

FIG. 3a is a scheme for a chemical reaction where the properties of the polymer are altered by modifying the pH of the liquid containing the polymer by dissolving CO₂ in the liquid thereby causing the pH of the solution to become acidic due to generation of carbonic acid or the removal of CO₂ from the liquid. As shown in FIG. 3a, in some embodiments, adding CO₂ can switch the polymer from its hydrophobic state to its hydrophilic state. As also shown in FIG. 3a, in certain embodiments, removing CO₂ can switch the polymer from its hydrophilic state to its hydrophobic state. In some embodiments, CO₂ can be removed by flowing a gas through the liquid that contains the polymer. Examples of inert gases include nitrogen (N₂), helium, neon, argon, and xenon. Although FIG. 3a refers to an inert gas, in some embodiments, CO₂ can be removed by flowing a non-inert gas (e.g., a gas present naturally in the reservoir, a hydrocarbon, such as methane (CH₄), ethane (C₂H₆), and/or propane (C₃H₈)) through the liquid that contains the polymer. FIG. 3a further shows that, in certain embodiments, CO₂ can be removed from the liquid that contains the polymer by heating the liquid. In general, the temperature needed to remove CO₂ from the liquid depends on the properties of the functional group R. In some embodiments, CO₂ can be removed from the liquid that contains the polymer by heating the liquid to a temperature of at least 20 (e.g. at least 30, at least 40, at least 50, at least 60)° C. and at most 100 (e.g. at most 90, at most 80, at most 70, at most 60)° C.

In addition, FIG. 3a shows that, in some embodiments, the polymer can contain a functional group that is positively charged upon protonation. In some embodiments, the functional group undergoes protonation and forms a salt with a bicarbonate anion when CO₂ is dissolved in the liquid that contains the polymer. In certain embodiments, the functional group undergoes deprotonation when CO₂ is removed from the liquid that contains the polymer. In some embodiments, the polymer is hydrophilic in the presence of such dissolved CO₂. In certain embodiments, the polymer is hydrophobic in the absence of such dissolved CO₂. An excess of CO₂ may be used to ensure all switchable functional groups are protonated to cause complete conversion to the hydrophilic state.

FIG. 3b is a scheme for a chemical reaction where the properties of the polymer are altered by changing the pH of the liquid containing the polymer due to the addition of an acid to the liquid (to decrease the pH of the liquid) or due to the addition of a base to the liquid (to increase the pH of the liquid). As shown in FIG. 3b, in some embodiments, a functional group in the polymer undergoes protonation upon addition of an acid. As also shown in FIG. 3b, in certain embodiments, a functional group in the polymer gains a positive charge upon addition of an acid. Examples of acids include inorganic acids (e.g., HCl, H₂S) and organic acids (e.g., acetic acid, formic acid, citric acid, oxalic acid, lactic acid, methansulfonic acid). FIG. 3b shows that, in some embodiments, a functional group in the polymer undergoes deprotonation upon addition of a base. FIG. 3b also shows that, in certain embodiments, a functional group in the polymer becomes neutral upon addition of a base. Examples of bases include NaOH, KOH, amine bases such as dimethyl amine, amide bases such as dimethylformamide (DMF), pyridine and imidazole. In some embodiments, the polymer is hydrophilic at a pH of at least 0 (e.g. at least 1, at least 2, at least 3, at least 4, at least 5, at least 6, at least 7) and at most 8 (e.g. at most 6, at most 5, at most 4). In some embodiments, the polymer is hydrophobic at a pH of at least 6 (e.g. at least 7, at least 8, at least 9) and at most 12 (e.g. at most 11, at most 10, at most 9, at most 8, at most 7).

As shown in FIGS. 3a and 3b, in certain embodiments, the hydrophilic form of the polymer is soluble in water, and the hydrophobic form of the polymer is insoluble in water. In some embodiments, the hydrophobic form of the polymer is soluble in a fluid (e.g., a hydrocarbon, such as crude oil) in a hydrocarbon-producing zone of a subterranean rock formation. In some embodiments, the hydrophobic form of the polymer forms a precipitate and/or a gel in water. In certain embodiments, while the precipitate and/or gel is not soluble in water, the precipitate and/or gel is soluble in a fluid (e.g., a hydrocarbon, such as crude oil) in a hydrocarbon-producing zone of a subterranean rock formation.

In certain embodiments, a salt may be used to influence the solubility of the polymer. In some embodiments, the salt may be used to increase precipitation of the polymer. Without wishing to be bound by theory, it is believed that an increase in salinity may increase hydrophobic interactions in polymers in the hydrophobic state. An increase in salinity may also induce charge deshielding and increase the amount of hydrophobic attraction in polymers in the hydrophilic state. Examples of salts include chloride and bromine containing salts with Group I and II cations such as potassium chloride (KCl), sodium chloride (NaCl), calcium chloride (CaCl₂) and magnesium chloride (MgCl₂).

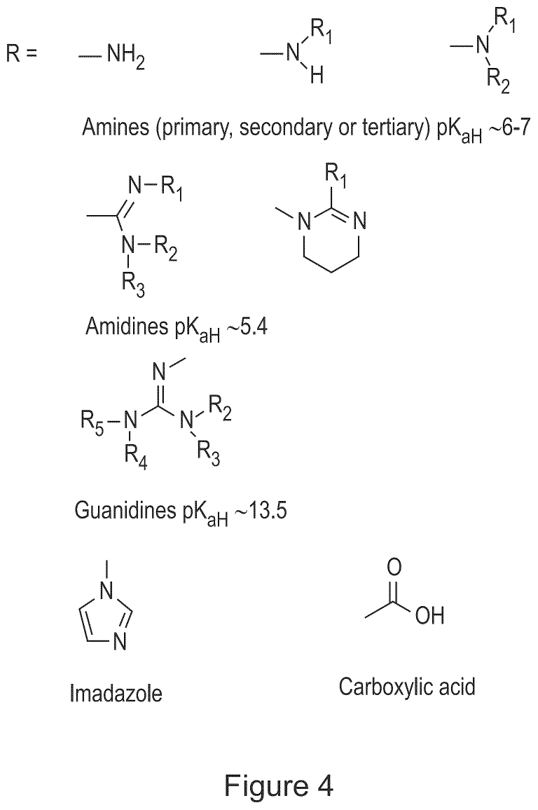

Generally, the polymer can include any pH and CO₂ responsive functional group. As used herein, a pH and CO₂ responsive functional group may be defined as a functional group that can react with an acid (e.g. carbonic acid generated by dissolved CO₂, HCl) to form a salt as shown in FIGS. 3a and 3b. In certain embodiments, the conversion of the acid to a salt converts the polymer from the hydrophobic to the hydrophilic state. In certain embodiments, the pH and CO₂ responsive group is an organobase. In certain embodiments, the pH and CO₂ responsive group (represented by R in 3a and 3b) is selected from amidines (including aryl amidines), amines, guanidines, imidazole, carboxylic acid, carbonyl, pyridine, sulfonic and phosphate. In certain embodiments, the pH and CO₂ responsive group is a tertiary amine. Structures of examples of functional groups are shown in FIG. 4.

In some embodiments, the ability to switch between the hydrophobic and hydrophilic states of the polymer is determined by the basicity of the functional group. In general, polymers with functional groups with lower pK_{aH} are easier to deprotonate and switch compared to functional groups with higher pK_{aH}. In some embodiments, the functional groups have a pK_{aH} of at least 3 (e.g. at least 4, at least 5, at least 6) and at most 7 (e.g. at most 6, at most 5, at most 4). Generally, the polymers have a relatively large change in the degree of protonation upon the addition or removal of CO₂.

In certain embodiments, the number of moles of the functional group per liter of aqueous solution containing the polymer is determined by the pK_{aH} of the functional group. In certain embodiments, a concentration of at least 0.1 (e.g. at least 1, at least 10) mM and at most 1000 (e.g. at most 100, at most 10) mM is used to see a change in polymer properties.

In certain embodiments, the chain length of the polymer is at least 20 (e.g. at least 50, at least 100, at least 200, at least 1000, at least 2000) units and at most 20,000 (e.g. at most 10,000 at most 5,000, at most 2,000, at most 1,000, at most 200) units. In certain embodiments, the molecular weight of the polymer is at least 2,000 (e.g. at least 5,000, at least 10,000, at least 50,000, at least 100,000, at least 200,000) grams per mole (g/mol) and at most 2,000,000 (e.g. at most 1,000,000, at most 500,000, at most 200,000, at most 100,000, at most 50,000, at most 20,000)g/mol.

In some embodiments, the monomers to prepare the polymers of the disclosure include N,N-dimethylaminoethyl methacrylate (DMAEMA), N,N-diethylaminoethyl methacrylate (DEAEMA), 3-N′,N′-dimethylaminopropyl acrylamide, N,N-diethylaminoacrylamide (DEAA), N,N-dimethyl acrylamide (DMAAm), N-isopropyl acrylamide (NIPAm), N-isopropylmethacrylamide (NIPMAm), 4-vinyl pyridine, 2-vinyl pyridine, acrylated ethyleneimine, (N-amidino)dodecyl acrylamide, N[3-(dimethylamino)propyl] methacrylamide (DMAPMAm), diallyl amine, 2-N-morpholinoethyl methacrylate (MEMA), acrylamide (Am), N,N-dimethylaminoethyl acrylate (DMAEA), N,N-diethylaminoethyl acrylamide (DEAEAm), N,N-dimethylvinylbenzylamine, N,N-diethylvinylbenzylamine, N,N-dipropylvinylbenzylamine, N-vinyl pyridine, and/or N-vinylimidazole.

As used herein, a polymer is said to have a given monomer or functional group if the polymer was formed from a monomer having that functional group even though, due to the polymerization reaction, the polymer may not contain the exact structure of the monomer. For example, a polymer synthesized from styrene may be referred to as polystyrene and be said to contain a styrene group or groups even though, due to the polymerization reaction, the polymer does not include the styrene group but rather a phenyl group. Similarly, a polymer synthesized from DEAEMA may be referred to as polyDEAEMA and be said to contain a DEAEMA group or groups despite the fact that the polymer does not contain the exact DEAEMA chemical structure. In this case, the polyDEAEMA contains the same pH and CO₂ responsive functional group found in monomeric DEAEMA.

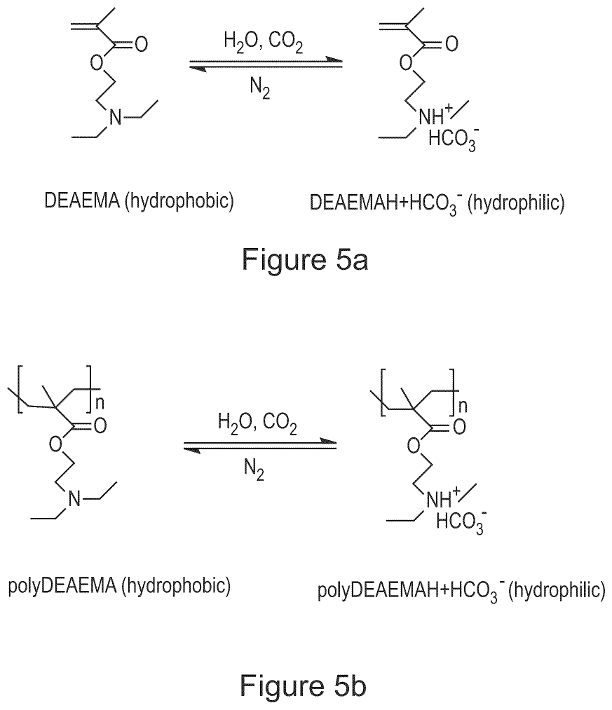

Reaction schemes for the protonation and deprotonation of the monomeric DEAEMA and polyDEAEMA are shown in FIGS. 5a and 5b, respectively. As shown in FIG. 5a, in the presence of CO₂, hydrophobic DEAEMA can form a bicarbonate salt and become a hydrophilic monomer or polymer with greater water solubility relative to the neutral monomer or polymer. As shown in FIG. 5b, N₂ gas can be added to remove the CO₂ and revert the bicarbonate salt to the neutral polymer. Generally, a tertiary amine is a moderate base with a pK_{aH} of 6.0-7.0.

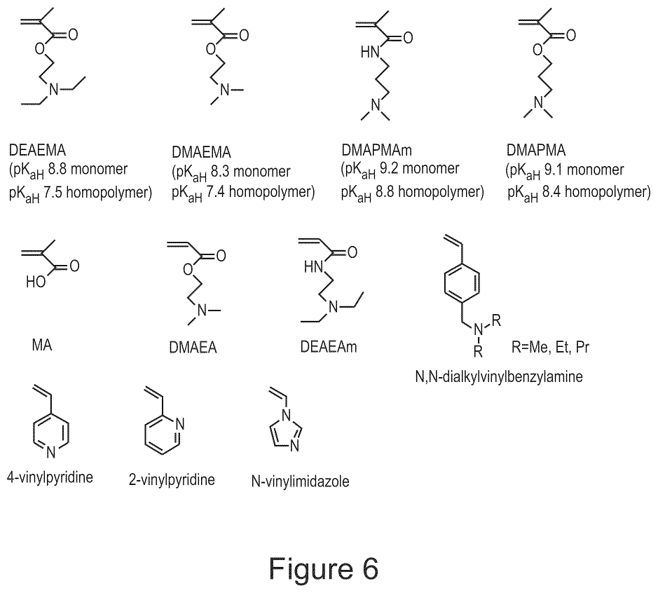

FIG. 6 shows the structures of several monomers with solubility that can be altered by the presence of CO₂ and changes in pH.

The monomers containing the basic functional group can be copolymerized with other monomers to influence the solubility of the polymer. In some embodiments, a hydrophobic monomer is added to the polymer to improve solubility in a fluid in a hydrocarbon-producing zone (e.g. crude oil, a hydrocarbon). In some embodiments, increasing the mole percent of the hydrophobic monomer in the polymer increases the hydrophobicity of the polymer. In some embodiments, the hydrophobic monomers include styrene, styrene sulfonate, 2,2,3,4,4,4-hexafluorobutyl methacrylate, N-cyclopropyl acrylamide, polyethylene oxide acrylate, methyl methacrylate, methyl acrylate, 2-ethylhexylacrylate, 2-hydroxypropyl methacrylate, hydroxyethyl methacrylate, n-butyl acrylate, t-butyl acrylate, ethyl acrylate, butyl methacrylate, ethyl cyanoacrylate, vinyl acetate, acrylonitrile, N-vinylpyrrolidone, N-vinylcaprolactam, N-vinylformamide, n-vinylacetamide, and/or N,N-diphenyl acrylamide.

In some embodiments, at least 40 (e.g. at least 50, at least 60, at least 70, at least 80, at least 90) percent (%) of the monomers in the polymer and at most 99 (e.g. at most 98, at most 95, at most 90, at most 80, at most 70, at most 60, at most 50) % of the monomers in the polymer may be the monomer with the basic functional group. In some embodiments, at least 1 (e.g. at least 2, at least 5, at least 10, at least 20, at least 30, at least 40, at least 50) % of the monomers in the polymer and at most 60 (e.g. at most 50, at most 40, at most 30, at most 20, at most 10) % of the monomers in the polymer may be the hydrophobic monomer.

In certain embodiments, the polymers of the disclosure may be synthesized by free radical initiation. In certain embodiments, a free radical initiator is used. In certain embodiments, the free radical initiator is water-soluble. In certain embodiments, the free radical initiator is oil-soluble. In certain embodiments, the free radical initiator is soluble in organic solvents. In certain embodiments, the free radical initiator is selected from ammonium persulfate, potassium persulfate, sodium persulfate, dibenzoyl peroxide, t-butylhydroperoxide, methyl ethyl ketone peroxide, alkyl peroxide, acyl peroxide, azobisisobutyronitrile (AIBN), 2,2′-Azobis[N-(2-carboxyethyl)-2-methylpropionamidine] n-Hydrate, 2,2′-Azobis[2-methyl-N-(2-hydroxyethyl)propionamide], 2,2′-Azobis(2-methylpropionamidine)dihydrochloride (VA-50), 1,1′-Azobis(cyclohexane-1-carbonitrile), 2,2′-Azobis(2-methylbutyronitrile), 2,2′-Azobis[2-(2-imidazolin-2-yl)propane]dihydrochloride (VA-044), 2,2′-Azobis[2-(2-imidazolin-2-yl)propane (VA-061), 2,2′-Azobis[N-(2-carboxyethyl)-2-methylpropionamidine]hydrate, and 2,2′-Azobis(2-methylbutyronitrile).

In some embodiments, redox initiators may be used in the synthesis of polymers of the disclosure. In some embodiments, a redox couple is selected from t-butylhydroperoxide and sodium metabisulfite, Fe²⁺/H₂O₂ (Fenton's Reagent), Fe²⁺/disulfide, Fe²⁺/persulfate, and dibenzoyl peroxide/tertiary aromatic amine such as N,N-dimethylaniline.

In certain embodiments, the polymers of the disclosure may be synthesized by free radical polymerization, atom transfer radical polymerization (ATRP), reversible addition-fragmentation transfer (RAFT), or nitroxide mediated polymerization.

In some embodiments, the polymers may be linear. In some embodiments, the polymers may be branched. In some embodiments, the polymers can have a network structure. In some embodiments, the polymers can be a homopolymer. In some embodiments, the polymer can be a random copolymer. In some embodiments, the polymer can be a block copolymer. In some embodiments, the polymer can be a triblock copolymer. In some embodiments, the polymer can be a star-shaped polymer.

In certain embodiments, pH and CO₂ responsive functional groups may be added to a polymer to make the polymer a switchable polymer. In certain embodiments, the pH and CO₂ responsive functional groups may be grafted to a polymer to make the polymer a switchable polymer. In certain embodiments, the polymer may be cellulose and derivatives thereof such as carboxymethyl cellulose (CMC), and hydroxypropyl cellulose; guar and guar-based derivatives such hydroxypropylguar (HPG), and carboxymethylhydrooxypropyl guar (CMHPG); polyacrylamide derivatives; chitosan; or polyacrylate derivatives with a grafted pH and CO₂ responsive functional group.

Generally, the polymer in its hydrophilic state is added to the subterranean rock formation. In certain embodiments, a solution (e.g., an aqueous solution) containing the polymer and bicarbonate anions is disposed in the subterranean rock formation. In some embodiments, the solution may be added to the formation via injection (e.g., bullheading).

In certain embodiments, the solution contains a molar ratio of at least 1:1 (e.g. at least 2:1, at least 3:1, at least 5:1) and a molar ratio of at most 20:1 (e.g. at least 15:1, at least 10:1) of the bicarbonate anion relative to the functional group in the polymer. In certain embodiments, when added to the subterranean rock formation, the solution contains at least 0.1 (e.g. at least 0.2, at least 0.5, at least 1) weight percent (wt. %) of the polymer and at most 10 (e.g. at most 5, at most 2, at most 1) wt. % of the polymer.

In some embodiments, after disposing the solution containing the polymer in the subterranean rock formation, heat in the subterranean rock formation will heat the solution that contains the polymer and displace CO₂, thereby switching the polymer from its hydrophilic state to its hydrophobic state. In certain embodiments, after disposing the solution containing the polymer in the subterranean rock formation, a gas is flowed into the formation to displace CO₂ and switch the polymer from its hydrophilic state to its hydrophobic state. In some embodiments, after disposing the solution containing the polymer in the subterranean rock formation, buffering action of the subterranean rock formation may alter the pH and switch the polymer from its hydrophilic state to its hydrophobic state.

In some embodiments, when the polymer is in its hydrophobic state, the polymer forms a gel or a precipitate, which initially blocks fluid communication between the interior of the well casing and both the hydrocarbon-producing zone and the water-producing zone. However, over time, the gel or precipitate can dissolve in a fluid (e.g., a hydrocarbon, such as crude oil) from the hydrocarbon-producing zone enabling fluid communication between the hydrocarbon-producing zone and the interior of the well casing, while still blocking fluid communication between the interior of the well casing and the water-producing zone. In some embodiments, it may be desirable to dissolve the precipitate and/or gel at some later time, for example, to prevent permanent plugging of the well or to otherwise potential damage to the well. In such embodiments, an acidic solution, such as a solution of HCl, can be disposed (e.g., bullheaded) into the rock formation to dissolve the precipitate and/or gel.

In some embodiments, the hydrocarbon-producing zone has pores and/or the water-producing zone has pores. In certain embodiments, the polymer (e.g., in the form of a precipitate or a gel, see discussion above) is disposed in the pores of the hydrocarbon-producing zone and/or the water-producing zone. In some embodiments, the precipitate or gel can at least partially block the pores in the water-producing zone to reduce (e.g., prevent) fluid communication between the water-producing zone and the interior of the well casing. In certain embodiments, the precipitate or gel present in the hydrocarbon-producing zone is soluble in a fluid (e.g., a hydrocarbon, such as crude oil) from the hydrocarbon-producing zone, thereby dissolving the precipitate or gel in the hydrocarbon-producing zone and allowing fluid communication between the hydrocarbon-producing zone and the interior of the well casing while preventing fluid communication between the water-producing zone and the interior of the well casing.

### EXAMPLES

### Example 1: Synthesis of Poly(DMAAm-co-DEAEMA)

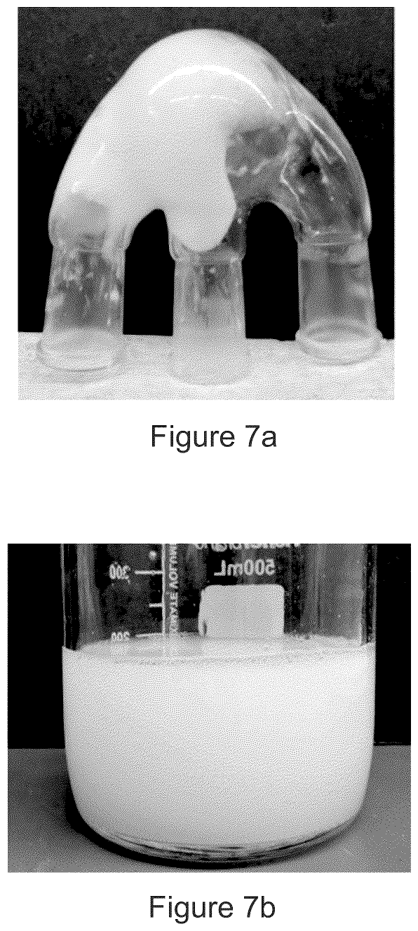

2-(Diethylamino)ethyl methacrylate (DEAEMA) (Sigma Aldrich) (2.2 g, 11.8 mmol) and N-N′-dimethylacrylamide (DMAAm) (Sigma Aldrich) (4.6 g, 46.4 mmol), corresponding to feed ratios of 20 mol % and 80 mol % DEAEMA and DMAAm, respectively, were added to 33.4 mL of DI-H₂O at room temperature. N₂ gas was bubbled through the solution for 45 min to displace any dissolved oxygen. While still at room temperature, potassium persulfate (KPS) (Sigma Aldrich, CAS #7727-21-1) (0.031 g, 0.115 mmol) was added to the reaction mixture. N₂ gas continued to be bubbled through this solution for an additional 15 minutes, during which an exothermic polymerization was accompanied by the formation of a viscous fluid that was opaque/milky in appearance owing to the hydrophobic nature of the material. The sample was then left to polymerize for at least 24 h at room temperature to yield a hydrogel consisting of 16.9 wt. % active copolymer. FIG. 7a shows a photograph of the as-synthesized poly(DMAAm-co-DEAEMA) hydrogel.

### Example 2: Viscosity Assessment as a Function of pH Changes and Salt Content

A 2% aqueous-based copolymer solution (200 mL) was prepared to investigate the viscosity profile for the material as a function of changes in pH. FIG. 7b shows a photograph of the 2% aqueous copolymer solution (pH: 9.31).

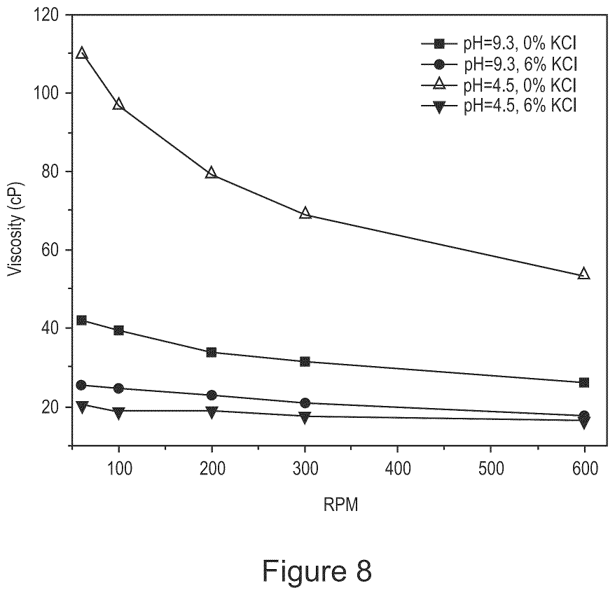

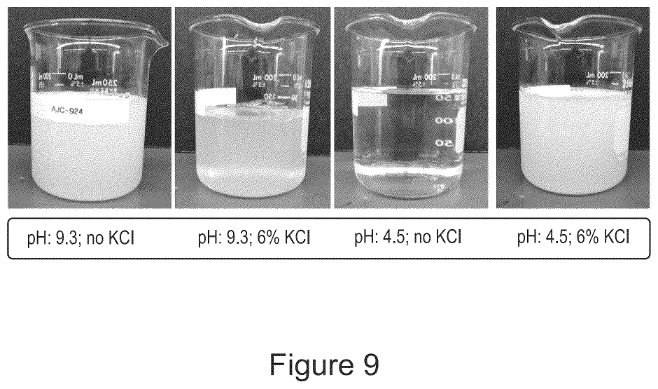

Viscosity measurements were performed using an M3600 viscometer (Grace Instruments) at room temperature and ambient pressure. Viscosity measurements for the 2% poly(DMAAm-co-DEAEMA) copolymer solution were measured at a pH of 9.3, which represented the conditions for the as-prepared solution with the polymer in the hydrophobic state and at a pH of 4.5 which was representative of that of carbonic acid rendering the copolymer in its hydrophilic (soluble) state. The pH was adjusted using HCl but analogous results were expected upon bubbling CO₂ gas through the solution in order to achieve the desired pH. The results of the viscosity measurements are presented in Table 1 and FIG. 8 with values reported in centipoise (cP). Photographs of the solutions at a pH of 9.3 or 4.5 and in the absence and presence of 6 weight percent (wt. %) KCl are shown in FIG. 9.

TABLE 1
Viscosity measurements for 2%
poly(DMAAm-co-DEAEMA) copolymer

| | 60 | 100 | 200 | 300 | 600 |
|---|---|---|---|---|---|
| Conditions | RPM | RPM | RPM | RPM | RPM |
| pH 9.3 | 42 | 39.4 | 33.8 | 31.5 | 26.1 |
| pH 9.3 with | 25.4 | 24.7 | 22.9 | 20.9 | 17.5 |
| 6% KCl | | | | | |
| pH 4.5 | 110 | 97 | 79.4 | 69 | 53.6 |
| pH 4.5 with | 20.5 | 18.8 | 19.1 | 17.6 | 16.4 |
| 6% KCl | | | | | |

As seen from Table 1 and FIGS. 8-9, at pH 9.31 the viscosity of the polymer was lower relative to pH 4.5 and the solution was milky, suggesting that hydrophobic attraction and precipitation was occurring. Solid domain formation occurred due to hydrophobic attraction. Using more hydrophobic monomers would be expected to provide an even lower viscosity or cause precipitation of polymer at this pH. At pH 4.5 the polymer was cationic and more hydrophilic. Thus, the polymer chains were extended due to charge repulsion and the viscosity was higher relative to pH 9.3. At this pH, water retention by the polymer was enhanced relative to pH 9.3, which increased the viscosity.

Additionally, the salinity of the solution was adjusted through the addition of 6 wt. % potassium chloride (KCl) to tailor the viscosity profile and assist with precipitation. As shown in Table 1 and FIGS. 8-9, addition of 6% KCl led to lower viscosity at low and high pH ranges as compared to the copolymer solution in the absence of the salt additive. At high pH, the polymer was in a neutral state and hydrophobic attraction was occurring. Addition of salt enhanced the hydrophobic attraction, further decreasing the viscosity of the polymer solution. At low pH the viscosity was reduced due to charge deshielding due to the ionic nature of the solution. Therefore, the polymer may experience hydrophobic attraction, which turned the solution milky and reduced the viscosity.

As shown in Table 1, on average the fluid viscosity was higher under higher pH conditions, while less viscous in the pH range synonymous with that of carbonic acid.

In the charged form, the switchable polymer was soluble in water and had a higher viscosity relative to the uncharged form. In the uncharged form, the viscosity was reduced relative to the charged form and precipitated. The precipitation of the switchable polymer to reduce (e.g. prevent) fluid communication between a water source and the interior of the well casing can be assisted with salt which promoted hydrophobic attraction.

What is claimed:

1. A system, comprising:
a well comprising a well casing having an interior; and
a polymer in both a water-producing zone of a subterranean rock formation and in a hydrocarbon-producing zone of the subterranean rock formation,
wherein:
the polymer has a hydrophobic state and a hydrophilic state;
when the polymer is in its hydrophilic state, the interior of the well casing is in fluid communication with both the hydrocarbon-producing zone and the water-producing zone;
when the polymer is in its hydrophobic state, the interior of the well casing is in fluid communication with the hydrocarbon-producing zone; and
fluid communication between the water-producing zone and the interior of the well casing is greater when the polymer is in its hydrophilic state than when the polymer is in its hydrophobic state.

2. The system of claim 1, wherein the polymer is synthesized by free radical polymerization of a monomer selected from the group consisting of acrylamide, vinyl pyrrolidone, N,N-dimethylaminoethyl methacrylate (DMAEMA), N,N-diethylaminoethyl methacrylate (DEAEMA), 3-N′,N′-dimethylaminopropyl acrylamide, N,N-diethylaminoacrylamide (DEAA), N,N-dimethyl acrylamide (DMAAm), N-isopropyl acrylamide (NIPAm), N-isopropylmethacrylamide (NIPMAm), 4-vinyl pyridine, 2-vinyl pyridine, acrylated ethyleneimine, (N-amidino)dodecyl acrylamide, N[3-(dimethylamino)propyl] methacrylamide (DMAPMAm), diallyl amine, 2-N-morpholinoethyl methacrylate (MEMA), acrylamide (Am), N,N-dimethylaminoethyl acrylate (DMAEA), N,N-diethylaminoethyl acrylamide (DEAEAm), N,N-dimethylvinylbenzylamine, N,N-diethylvinylbenzylamine, N,N-dipropylvinylbenzylamine, N-vinyl pyridine, and N-vinylimidazole.

3. The system of claim 1, wherein the polymer is selected from the group consisting of a homopolymer, copolymer or terpolymer.

4. The system of claim 1, wherein the polymer comprises graft copolymer.

5. The system of claim 1, wherein the polymer comprises a biopolymer.

6. The system of claim 5, wherein the biopolymer comprises a member selected from the group consisting of guar, cellulose, CMC, and CMHPG.

7. The system of claim 1, wherein the polymer comprises a monomer comprising a functional group capable of switching the polymer between the hydrophobic state and the hydrophilic state.

8. The system of claim 1, wherein, in its hydrophobic state, the polymer prevents or reduces an amount of water from the water-producing zone from entering the interior of the well casing.

9. The system of claim 1, wherein, when the polymer is in its hydrophobic state, the polymer is soluble in produced oil in the hydrocarbon-producing zone so that the polymer does not block hydrocarbon production from the hydrocarbon-producing zone.

10. The system of claim 1, wherein, when the polymer is heated, the polymer switches from its hydrophilic state to its hydrophobic state.

11. The system of claim 1, wherein, when as a pH of a liquid comprising the polymer is increased, the polymer switches from its hydrophilic state to its hydrophobic state.

12. The system of claim 1, wherein, when the polymer and carbon dioxide are dissolved in an aqueous liquid and carbon dioxide is removed from the liquid, the polymer switches from its hydrophilic state to its hydrophobic state.

13. The system of claim 1, wherein the hydrophilic state of the polymer comprises a cation of a salt.

14. The system of claim 11, wherein the salt comprises a member selected from the group consisting of a bicarbonate salt and a chloride salt.

15. The system of claim 1, wherein a functional group of the polymer is deprotonated when the polymer switches from its hydrophilic state to its hydrophobic state.

16. The system of claim 15, wherein the functional group has a neutral charge when deprotonated and a positive charge when protonated.

17. The system of claim 15, wherein the functional group has a pK_{aH} of from 3 to 9.

18. The system of claim 15, further comprising a liquid comprising the polymer, wherein the mole ratio between the functional group and a bicarbonate anion in the liquid is from 1:1 to 1:20.

19. The system of claim 15, wherein the functional group comprises a member selected from the group consisting of amines, amidines, guanidines, imidazole and carboxylic acid.

20. The system of claim 15, wherein the polymer further comprises a hydrophobic functional group.

21. The system of claim 15, wherein the functional group comprises at least one member selected from the group consisting of N,N-dimethylaminoethyl methacrylate (DMAEMA), N,N-diethylaminoethyl methacrylate (DEAEMA), 3-N′,N′-dimethylaminopropyl acrylamide, N,N-diethylaminoacrylamide (DEAA), N,N-dimethyl acrylamide (DMAAm), N-isopropyl acrylamide (NIPAm), N-isopropylmethacrylamide (NIPMAm), 4-vinyl pyridine, 2-vinyl pyridine, acrylated ethyleneimine, (N-amidino)dodecyl acrylamide, N[3-(dimethylamino)propyl] methacrylamide (DMAPMAm), diallyl amine, 2-N-morpholinoethyl methacrylate (MEMA), acrylamide (Am), N,N-dimethylaminoethyl acrylate (DMAEA), N,N-diethylaminoethyl acrylamide (DEAEAm), N,N-dimethylvinylbenzylamine, N,N-diethylvinylbenzylamine, N,N-dipropylvinylbenzylamine, N-vinyl pyridine, and N-vinylimidazole.

22. The system of claim 1, wherein the polymer can reduce or block water production due to at least one member selected from the group consisting of casing leaks, tubing and packer leaks, water channel behind pipes, barrier breakdown, coning and cusping of water, channeling through high permeability zones, fractures, and wormholes.

23. A method of reducing water production in a hydrocarbon-producing well in fluid communication with both a water-producing zone of a subterranean formation and a hydrocarbon-producing zone of the subterranean formation, a polymer being disposed in both the hydrocarbon-producing zone and the water-producing zone, the polymer having a hydrophilic state and a hydrophobic state, the method comprising:
switching the polymer from its hydrophilic state to its hydrophobic state to reduce water production from the water-producing zone.

24. The method of claim 23, further comprising, after switching the polymer to its hydrophobic state, flowing hydrocarbon fluid from the hydrocarbon-producing zone to the well.

25. The method of claim 23, wherein switching the polymer to its hydrophobic state comprises heating the polymer.

26. The method of claim 23, wherein the polymer is in a liquid, and switching the polymer to its hydrophobic state comprises exposing the liquid to a gas.

27. The method of claim 23, wherein the polymer and carbon dioxide are dissolved in a liquid, and switching the polymer to its hydrophobic state comprises removing carbon dioxide from the liquid.

28. A method for excess water control for a hydrocarbon producing well, the method comprising:
providing a polymer capable of being reversibly switched between a hydrophobic state and a hydrophilic state by converting neutral state of polymer to forming its salt with acidic groups;
forming a fluid comprising the polymer in an aqueous medium by converting to the hydrophilic state by forming its salt;
pumping the hydrophilic fluid or gel through the well into the oil producing zone and water producing zone in the formation;
allowing the hydrophilic gel to switch to hydrophobic state by action of heat, passing formation gas or by buffering action of formation or a combination thereof;
wherein:
in its hydrophobic state, the polymer forms a gel or precipitate that plugs the water producing zone to reduce or stop water production; and
when present in the hydrocarbon zone, the polymer in its hydrophobic state dissolves in the hydrocarbon leaving the oil producing zone unobstructed.
